(19) United States
(12) Patent Application Publication
(10) Pub. No.: US 2026/0064094 A1
(43) Pub. Date: Mar. 5, 2026

(54) DOMESTIC APPLIANCE SERVICING SYSTEMS AND METHODS

(71) Applicant: Haier US Appliance Solutions, Inc., Wilmington, DE (US)

(72) Inventors: Intae Kim, Seoul (KR); Myunggeon Chung, Seoul (KR); Seonghoon Ryu, Suwon (KR)

(21) Appl. No.: 18/819,638

(22) Filed: Aug. 29, 2024

(51) Int. Cl. G05B 15/02; G06Q 10/20

(52) U.S. Cl. CPC G05B 15/02; G06Q 10/20; G05B 2219/2642

(57) ABSTRACT

A method of identifying a set of target user accounts may include obtaining, from a first user account at a remote server, fault code data for a first domestic appliance. The first user account may be associated with the first domestic appliance. The method may include performing, at the remote server, a servicing analysis to identify one or more target user accounts. The servicing analysis may be based on the fault code data for the first domestic appliance. The method may include implementing a responsive action upon identifying the one or more target user accounts.

### FIELD OF THE DISCLOSURE

The present subject matter relates generally to domestic appliances and more particularly to systems and methods for identifying a set of target user accounts.

### BACKGROUND OF THE DISCLOSURE

Domestic (e.g., household) appliances are used generally for a variety of tasks by a variety of users. For example, a household may include such appliances as laundry appliances (e.g., a washing machine or dryer appliance), kitchen appliances (e.g., a refrigerator, an oven, a cooktop, a range hood, a microwave, dishwasher, etc.), along with air conditioners, water heaters and various other appliances.

Some domestic appliances can also include features for connecting to and communicating over a secure wireless network. Such communication may provide connected features on the domestic appliances to permit the domestic appliance to communicate with a personal device, smart home systems, or a remote database such as a cloud server.

Over time, domestic appliances may experience losses or degradation in performance (e.g., due to various types of usage often referred to as “faults”). A user may request a service technician to determine, diagnose, and fix these faults at the domestic appliance. However, further improvements are necessary to improve technician servicing for users. Often service technicians may be costly (e.g., due to travel expenses, part expenses, labor expenses, etc.) to a user. Thus, users can be reluctant to seek technical assistance. Delays in service often occur due to technicians lacking necessary parts. Thus, a user's frustration towards service technicians can be exacerbated. In addition, some users may not recognize the need for technician service when critical faults arise in their domestic appliance.

Accordingly, systems and methods that may obviate one or more of the above mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a method of identifying a set of target user accounts is provided. The method may include obtaining, from a first user account at a remote server, fault code data for a first domestic appliance.

The first user account may be associated with the first domestic appliance. The method may include performing, at the remote server, a servicing analysis to identify one or more target user accounts. The servicing analysis may be based on the fault code data for the first domestic appliance. The method may include implementing a responsive action upon identifying the one or more target user accounts.

In another exemplary aspect of the present disclosure, a system is provided. The system may include a first user account associated with a first domestic appliance in a first household. The system may include a set of prospective user accounts. Each prospective user account of the set of prospective user accounts associated with a discrete domestic appliance in a discrete household. The system may include a remote server communicatively coupled with the first household and each prospective household of the set of prospective households. The remote server may be operable for: obtaining, from a first user account, fault code data for a first domestic appliance, the first user account may be associated with the first domestic appliance; performing a servicing analysis to identify one or more target user accounts from the set of prospective user accounts, servicing analysis may be based on the fault code data for the first domestic appliance; and implementing a responsive action upon identifying the one or more target user accounts.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of domestic laundry appliances according to one or more exemplary embodiments of the present disclosure.

FIG. 2 provides a front, elevation view of domestic kitchen appliances according to one or more exemplary embodiments of the present disclosure.

FIG. 3 provides a schematic view of a system for communicating between multiple households according to one or more exemplary embodiments of the present disclosure.

FIG. 4 provides a flow chart illustrating a method of recommending technician service for nearby domestic appliances according to one or more exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising. ” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration. ” In addition, reference to “an embodiment” or “one embodiment”does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element. ” Furthermore, barring a specific statement to the contrary, any steps or functions recited as being performed by “the processing element” or “said processing element” are generally understood to be capable of being performed by “any one of the one or more processing elements. ” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed. ” Moreover, it is understood that recitation of “the processing element” or “said processing element” performing a plurality of steps or functions does not require that at least one discrete processing element be capable of performing each one of the plurality of steps or functions.

As should be appreciated, the terms “domestic appliance,” “household appliance,” or the like are used herein to describe appliances typically used or intended for common domestic tasks. According to still other embodiments, these “appliances” may include but are not limited to a refrigerator appliance, a dishwasher, a microwave oven, a cooktop, an oven, a washing machine, a dryer, and any other domestic or household appliance that includes a door handle that a user may grasp to manipulate a position of an exterior door or drawer thereof.

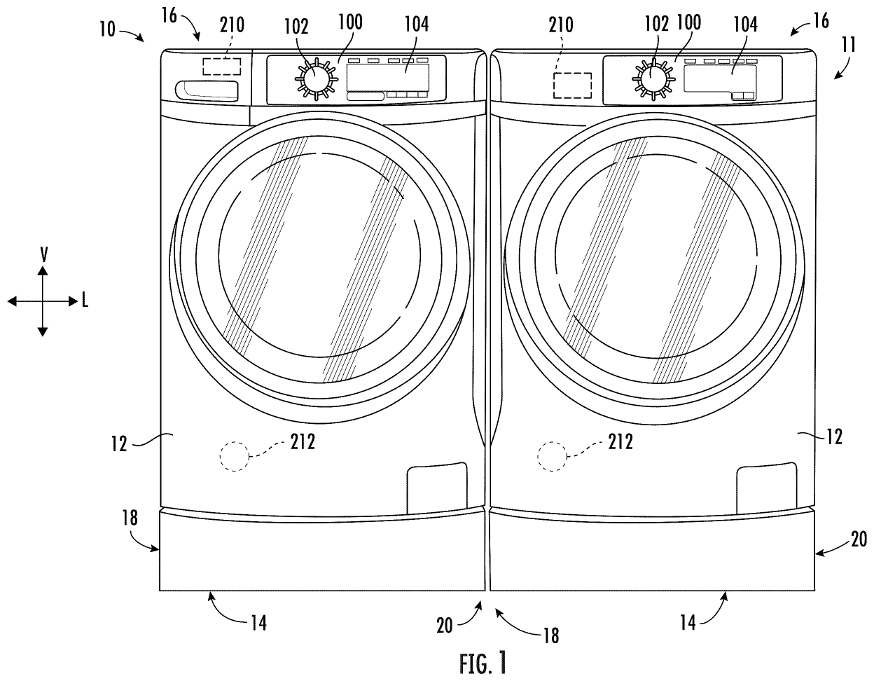

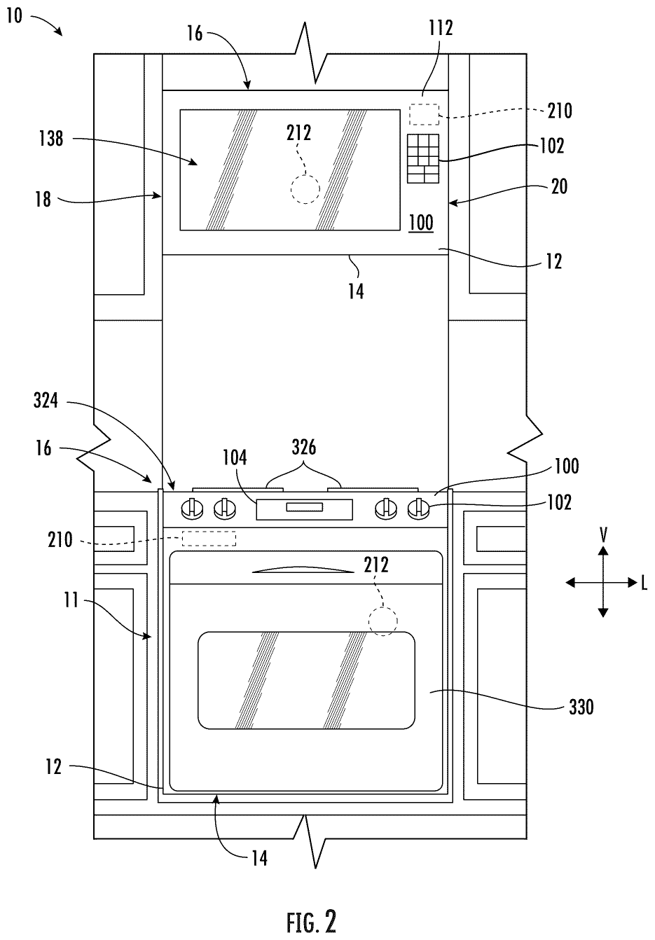

Referring now to the figures, FIGS. 1 and 2 provide one or more appliances, for instance, a first domestic appliance 10 and a second domestic appliance 11, that may be located in a household, dwelling, or any other suitable building that may house a domestic appliance. As generally shown throughout FIGS. 1 and 2, the first domestic appliance 10 and the second domestic appliance 11 may each include a cabinet 12 that defines a vertical direction V, a lateral direction L, and a transverse direction T that are mutually perpendicular. Each cabinet 12 extends between a top side 16 and a bottom side 14 along the vertical direction V. Each cabinet 12 also extends between a left side 18 and a right side 20 (e.g., along the lateral direction L) and a front side 22 and a rear side 24 (e.g., along the transverse direction T).

The first domestic appliance 10 or the second domestic appliance 11 may each include a user interface panel 100 and a control or user input device 102, which may be positioned on an exterior of the cabinet 12. The user input device 102 is generally positioned proximate to the user interface panel 100, and in some embodiments, the user input device 102 is positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Separate from or in addition to the user interface panel 100, the first domestic appliance 10 or the second domestic appliance 11 may each include one or more sensors 212 to detect one or more parameters relevant to the appliance. Specifically, such sensors 212 may detect physical conditions in or around the corresponding the first domestic appliance 10 or the second domestic appliance 11. Moreover, the detected physical conditions may be registered or measured as corresponding value (e.g., parameter value based on a voltage generated at the sensor 212). As a result, and as is generally understood, sensors 212 attached to the first domestic appliance 10 or the second domestic appliance 11 may detect, measure, or otherwise determine a set parameter.

Exemplary embodiments of sensors 212 may include or be provided as a temperature sensor (e.g., thermistor, thermocouple, optical temperature sensor, etc.), humidity sensor (e.g., capacitive, resistive, or thermal conductivity humidity sensor), pressure sensor (e.g., strain gauge, variable reluctance, potentiometric, inductive, capacitive, or piezoelectric pressure sensor), or any other suitable sensing device capable of electric communication of detected parameters. Nonetheless, the exact sensors or types will naturally depend on the particular appliance onto which a sensor is incorporated, and should not limit the type of sensors that may be encompassed by or included with the present disclosure.

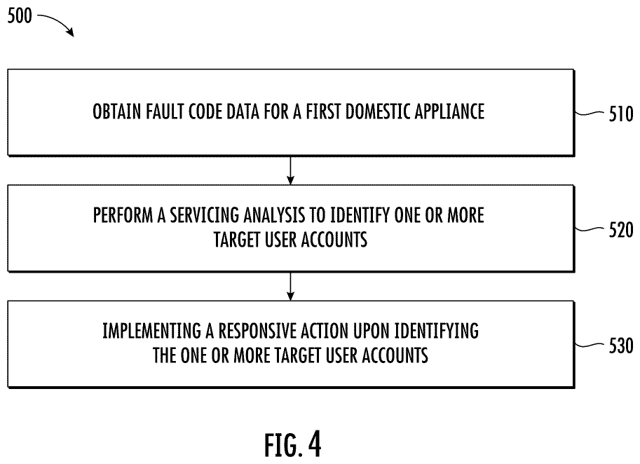

Generally, the first domestic appliance 10 or the second domestic appliance 11 may each include a controller 210 in operative communication with the user input device 102, sensors 212, and one more electronic assemblies 214 (e.g., electrically controlled physical components) (FIG. 4), such as a pump, fan, heating element, sealed system, etc. The user interface panel 100, user input device 102, sensors 212, and electronic assemblies 214 may be in communication with the controller 210 via, for example, one or more signal lines or shared communication busses. Input/output (“I/O”) signals may be routed between controller 210 and various operational components the first domestic appliance 10 or the second domestic appliance 11. Operation of the first domestic appliance 10 or the second domestic appliance 11 (e.g., as performed by the electronic assemblies 214) may each be regulated by the respective controller 210 that is operatively coupled to (i.e., in operative communication with) the corresponding user interface panel 100 or sensors 212. A user interface panel 100 may for example provide selections for user manipulation of the operation of an appliance (e.g., via user input device 102 or display 104). In response to user manipulation of the user interface panel 100 or signals received from one or more sensors 212, the controller 210 may operate the various components or electronic assemblies 214 of the first domestic appliance 10 or the second domestic appliance 11.

Each controller 210 may include a memory and one or more microprocessors, CPUs, or the like, such as general or special purpose microprocessors operable to execute programming instructions or micro-control code associated with operation of the first domestic appliance 10 or the second domestic appliance 11. The memory may represent random access memory such as DRAM, or read only memory such as ROM or FLASH. In some embodiments, the processor executes programming instructions stored in memory. The memory may be a separate component from the processor or may be included onboard within the processor. Alternatively, a controller 210 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

The controller 210 may be programmed to operate the respective the first domestic appliance 10 or the second domestic appliance 11 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions or instructions (e.g. performing the methods, steps, calculations, etc. and storing relevant data, as disclosed herein). It should be noted that controllers 210 as disclosed herein are capable of, and may be operable to perform, any methods and associated method steps as disclosed herein.

In some embodiments, for example, as illustrated in FIG. 1, a pair of laundry appliances may be provided as the first domestic appliance 10 or the second domestic appliance 11. In the exemplary embodiment illustrated in FIG. 1, the first domestic appliance 10 may be a washing machine appliance and the second domestic appliance 11 may be a dryer appliance. In embodiments such as illustrated in FIG. 1, the user input device 102 of the first domestic appliance 10 or the second domestic appliance 11 may each be positioned on the user interface panel 100. The embodiment illustrated in FIG. 1 also includes a display 104 on the user interface panel 100.

FIG. 2 illustrates another exemplary embodiment of a group of appliance where the first domestic appliance 10 or the second domestic appliance 11 is/are kitchen appliances. In this example, the first domestic appliance 10 is a microwave oven appliance that is generally positioned above the second domestic appliance 11, which is a cooktop appliance (e.g., along the vertical direction V).

Microwave oven appliance as first domestic appliance 10 includes a cabinet 12. A cooking chamber is defined within the cabinet 12 of the microwave oven appliance. The cooking chamber is accessible via a door 112 and viewable through a window 138 in the door 112. The microwave oven appliance is configured to heat articles (e.g., food or beverages) within the cooking chamber using electromagnetic radiation. The microwave oven appliance may include various components that operate to produce the electromagnetic radiation, as is generally understood. For example, the microwave oven appliance may include a magnetron (such as, for example, a cavity magnetron), a high voltage transformer, a high voltage capacitor, and a high voltage diode. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to the cooking chamber. The structure and intended function of microwave ovens are generally understood by those of ordinary skill in the art and are not described in further detail herein.

As shown, cooktop appliance as second domestic appliance 11 includes a chassis or cabinet 12 that extends along the vertical direction V between a top side 16 and a bottom side 14. The cooktop appliance can include a cooktop surface 324 having one or more heating elements 326 for use in, for example, heating or cooking operations. In exemplary embodiments, cooktop surface 324 is constructed with ceramic glass. In other embodiments, however, cooktop surface 324 may include any another suitable material, such as a metallic material (e.g., steel) or another suitable non-metallic material. Heating elements 326 may be various sizes and may employ any suitable method for heating or cooking an object, such as a cooking utensil (not shown), and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In various embodiments, the heating elements 326 may include one or more of a gas burner element, resistive heat element, radiant heat element, induction element, or another suitable heating element.

In some embodiments, the cabinet 12 of the cooktop appliance may be insulated and may define a cooking chamber selectively enclosed by a door 330. One or more heating elements (e.g., top broiling elements or bottom baking elements) may be positioned within cabinet 12 of the cooktop appliance to heat the cooking chamber. Heating elements within the cooking chamber may be provided as any suitable element for cooking the contents of cooking chamber, such as an electric resistive heating element, a gas burner, a microwave element, a halogen element, etc. Thus, the cooktop appliance may be referred to as an oven range appliance. As will be understood by those skilled in the art, the cooktop appliance is provided by way of example only, and the present subject matter may be used in the context of any suitable cooking appliance, such as a double oven range appliance or a standalone cooktop (e.g., fitted integrally with a surface of a kitchen counter). Thus, the exemplary embodiments illustrated and described are not intended to limit the present disclosure to any particular cooking chamber or heating element configuration, unless explicitly indicated as such.

As illustrated, a user interface panel 100 may be provided on the cooktop appliance. Although shown at front portion of the cooktop appliance, another suitable location or structure (e.g., a backsplash) for supporting user interface panel 100 may be provided in alternative embodiments. In some embodiments, user interface panel 100 includes user input device 102, such as one or more of a variety of electrical, mechanical, or electro-mechanical input devices. User input device 102 may include, for example, rotary dials, knobs, push buttons, and touch pads. A controller 210 is in communication with user interface panel 100 and user input device 102 through which a user may select various operational features and modes and monitor progress of the cooktop appliance. In additional or alternative embodiments, user interface panel 100 includes a display component, such as a digital or analog display in communication with a controller 210 and configured to provide operational feedback to a user. In certain embodiments, user interface panel 100 represents a general purpose I/O (“GPIO”) device or functional block.

As shown, controller 210 is communicatively coupled (i.e., in operative communication) with user interface panel 100 and its user input devices 102. Controller 210 may also be communicatively coupled with various operational components of cooktop appliance 300 as well, such as heating elements (e.g., 326, 332), sensors 212, and the like. Input/output (“I/O”) signals may be routed between controller 210 and the various operational components of the cooktop appliance. Thus, controller 210 can selectively activate and operate these various components. Various components of the cooktop appliance are communicatively coupled with controller 210 via one or more communication lines such as, for example, conductive signal lines, shared communication busses, or wireless communications bands.

According to various embodiments of the present disclosure, the first domestic appliance 10 or the second domestic appliance 11 may take the form of any of the examples described above or may be any other domestic appliance. For instance, one or more domestic appliances may be provided as a kitchen hub appliance, humidifier appliance, range appliance, water heater appliance, air conditioning appliance (e.g., PTAC, VTAC, etc.), microwave appliance, oven appliance, refrigerator appliance, or dishwasher appliances, including all of the associated features, electronic assemblies, and sensors, as would be understood. Thus, it will be understood that the present subject matter is not limited to any particular domestic appliance.

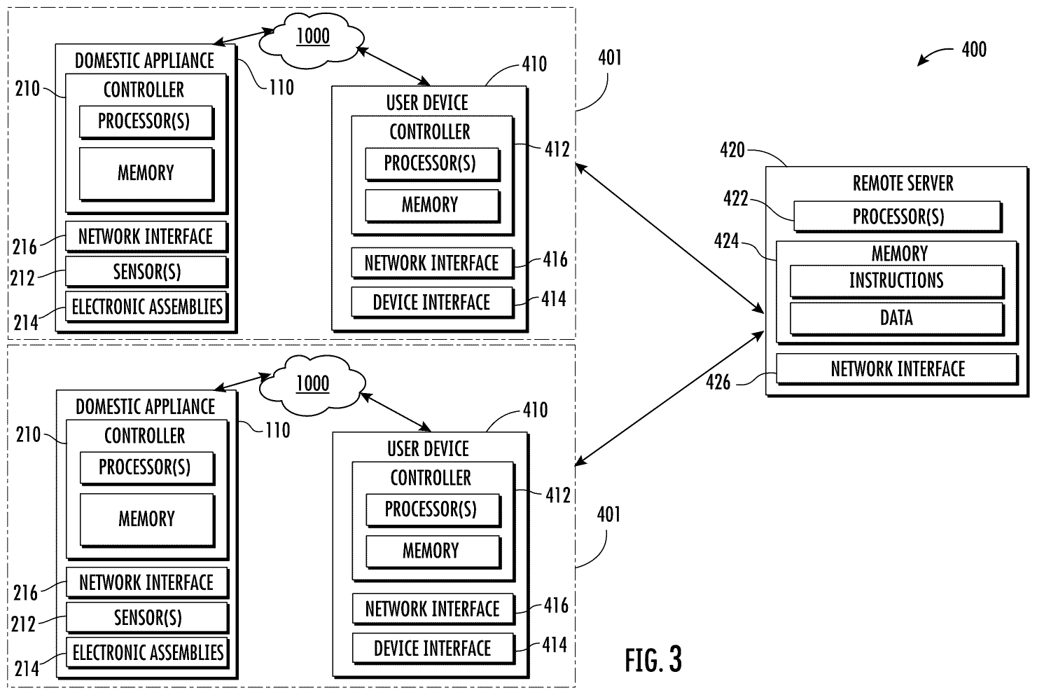

Turning now to FIG. 3, a system 400 will be described according to one or more exemplary embodiments of the present subject matter. In general, the system 400 may include a plurality of households 401 may each be in operative communication with a remote server 420. For the sake of brevity, only one household 401 will be described in greater detail herein. However, it should be appreciated that the description provided herein may apply to the any other suitable household 401 that may be in the system.

As illustrated in FIG. 3, the household 401 may include one or more domestic appliances 110 (e.g., first domestic appliance 10 or second domestic appliance 11—FIGS. 1 and 2) that may be configured to communicate with an external device. For instance, controller 210 of the domestic appliance 110 may be configured to communicate with another domestic appliance 110, a remote user device 410, or remote server 420, either directly or via one or more intermediate devices or networks (e.g., network 1000).

As noted above, the domestic appliance 110 may include a controller 210 that is communicatively coupled to one or more sensors 212 or electronic assemblies 214. Controller 210 may include one or more processors and one or more memory devices (i.e., memory). The one or more processors can be any suitable processing device (e.g., a processor core, a microprocessor, an ASIC, a FPGA, a microcontroller, etc.) and can be one processor or a plurality of processors that are operatively connected. The memory device can include one or more non-transitory computer-readable storage mediums, such as RAM, ROM, EEPROM, EPROM, flash memory device, magnetic disks, etc., and combinations thereof. The memory devices can store data and instructions that are executed by the processor to cause the domestic appliance 110 to perform operations. For example, instructions could be instructions for receiving/transmitting signals the sensors 212 or activating the electronic assemblies 214. The memory devices may also include data, such as one or more detected parameters, audio signals, video signals, instruction panels, etc., that can be retrieved, manipulated, created, or stored by processor.

Controller 210 includes a network interface 216 such that domestic appliance 110 can connect to and communicate over one or more networks (e.g., network 1000) with one or more network nodes. Network interface 216 can be an onboard component of controller 210 or it can be a separate, off board component.

Network interface 216 may also include or be provided as a global positioning system (GPS) receiver. Such a GPS receiver is generally configured for receiving transmissions from GPS satellites. As is understood, the GPS receiver can establish or determine a location of GPS receiver (and thus domestic appliance 110) using such transmissions.

Controller 210 can also include one or more transmitting, receiving, or transceiving components for transmitting/receiving communications with other devices communicatively coupled with domestic appliance 110. Additionally or alternatively, one or more transmitting, receiving, or transceiving components can be located off board controller 210.

Network 1000 can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 1000 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The remote user device 410 may be a laptop computer, smartphone, tablet, personal computer, wearable device, smart home system, or various other suitable devices including a device controller 412 and device interface 414 (e.g., buttons or touchscreen display). Generally, the remote user device 410 includes a device controller 412 having a memory (e.g., non-transitive storage media) for storing and retrieving programming instructions. For example, the remote user device 410 may be a smartphone operable to store and run applications (i.e., “apps”) and may include a remote user interface provided as a smartphone app. Device controller 412 may include a network interface 416 such that remote user device 410 can connect to and communicate over one or more networks (e.g., network 1000) with one or more network nodes. Network interface 416 can be an onboard component of device controller 412 or it can be a separate, off board component. Network interface 416 may include or be provided as a global positioning system (GPS) receiver. Such a GPS receiver is generally configured for receiving transmissions from GPS satellites. As is understood, the GPS receiver can establish or determine a location of GPS receiver (and thus domestic appliance 110) using such transmissions.

Device controller 412 can also include one or more transmitting, receiving, or transceiving components for transmitting/receiving communications with other devices communicatively coupled with remote user device 410. Additionally or alternatively, one or more transmitting, receiving, or transceiving components can be located off board controller 412.

In some embodiments, a remote server 420, such as a web server, is in operable communication with one or more domestic appliances 110 or remote devices 410. The remote server 420 can be used to host an engagement platform (e.g., for sharing or facilitating a pre-constructed table, sensor readings or parameter values, etc., such as for a user account associated with multiple domestic appliances 110). Additionally or alternatively, the remote server 420 can be used to host an information database (e.g., for storing user data or parameter values). The remote server 420 can be implemented using any suitable computing device(s). The remote server 420 may include one or more processors 422 and one or more memory devices 424 (i.e., memory). The one or more processors 422 can be any suitable processing device (e.g., a processor core, a microprocessor, an ASIC, a FPGA, a microcontroller, etc.) and can be one processor or a plurality of processors that are operatively connected. The memory device 424 can include one or more non-transitory computer-readable storage mediums, such as RAM, ROM, EEPROM, EPROM, flash memory devices, magnetic disks, etc., and combinations thereof. The memory devices 424 can store data and instructions which are executed by the processor 422 to cause remote server 420 to perform operations. For example, instructions could be instructions for receiving, transmitting, analyzing, or organizing parameter values from one or more domestic appliances 110.

The memory devices 424 may also include data that can be retrieved, manipulated, created, or stored by processor 422. The data can be stored in one or more databases. The one or more databases can be connected to remote server 420 by a high bandwidth LAN or WAN, or can also be connected to remote server 420 through network 1000. The one or more databases can be split up so that they are located in multiple locales.

Remote server 420 includes a network interface 426 such that interactive remote server 420 can connect to and communicate over one or more networks (e.g., network 1000) with one or more network nodes. Network interface 426 can be an onboard component or it can be a separate, off board component. In turn, remote server 420 can exchange data with one or more nodes over the network 1000. As an example, remote server 420 can exchange data with one or more domestic appliances 110 or user devices 410.

Generally, it is understood that remote server 420 may further exchange data with any number of client devices over the network 1000. The client devices can be any suitable type of computing device, such as a general-purpose computer, special purpose computer, laptop, desktop, integrated circuit, mobile device, smartphone, tablet, or other suitable computing device. In some embodiments, data, including parameter values from an appliance sensor 212, may thus be exchanged between domestic appliances 110. Remote server 420 (e.g., the processor(s) and memory device(s) thereof) can be configured to perform a variety of computer-implemented functions or instructions (e.g. performing the methods, steps, calculations, etc. and storing relevant data, as disclosed herein). It should be noted that remote server 420, as disclosed herein is capable of, and may be operable to perform, any methods and associated method steps as disclosed herein.

During use, domestic appliances 110 may be in communication with the separate user device 410 or remote server 420 through various possible communication connections and channels, such as but not limited to wireless radio frequency (RF) channels (e.g., ZIGBEE®, BLUETOOTH®, WI-FI®, etc.) or any other suitable communication connection.

Turning now to FIG. 4, a flow chart is provided of a method 500 according to one or more exemplary embodiments of the present disclosure. Generally, FIG. 4 provides a method of operating a domestic appliance. Over time, users of domestic appliances may encounter various operating issues, system faults, component failures, or general performance degradation (hereinafter generally referred to as “faults”). These faults may often prompt a technician service call from a user. However, many users hesitate to seek help from technician service calls for numerous reasons. For example, technician service calls may result in costly technician fees or may otherwise encumber the users experience with the domestic appliance as the technician may have to delay servicing due delays in part procurement, troubleshooting, or the like.

Methods in accordance with the present disclosure advantageously provide a method of identifying a set of target domestic appliances from a set of prospective domestic appliances, for instance, for recommending technician service to nearby domestic appliances experiencing similar fault codes. Notably, the method 500 may advantageously increase user experience. For example, by reducing or eliminating the need for users to immediately call for technician servicing upon fault code detection (e.g., as users will now be notified about the expected date and time that a technician will be performing similar services near to them). As another example, by allowing technicians to offer reduced rates to users when multiple similar services (e.g., spaced apart multiple households) are to be performed at similar times. As yet another example, by reducing servicing time (e.g., by allowing the technician to work on similar task requiring similar servicing across multiple households).

The method 500 can be performed, for instance, by a remote server. During operations, the remote server may send signals to and receive signals from two or more domestic appliances. The two or more domestic appliances each being in an individual household, dwelling, building, or any other suitable location that may house a domestic appliance. The two or more domestic appliances each being associated with a user account (e.g., separate user accounts).

FIG. 4 depicts steps performed in a particular order for purpose of illustration and discussion. Those of ordinary skill in the art, using the disclosures provided herein, will understand that the steps of any of the methods disclosed herein can be modified, adapted, rearranged, omitted, or expanded in various ways without deviating from the scope of the present disclosure (except as otherwise described).

At 510, the method 500 may include obtaining fault code data for a first domestic appliance (e.g., an oven appliance, a microwave appliance, a refrigerator appliance, or the like positioned within a first household). In some embodiments, the remote server continuously receives and monitors fault code data from the first domestic appliance. The remote server may monitor fault code data in order to identify common sources of problems and to generate global solutions to those problems. For example, the fault code data may be identified generally as “variables” received from the first domestic appliance and may include fault codes, temperature readings, current readings, voltage readings, or other aggregate data received from one or more sensors of the first domestic appliance. In this regard, the fault code data for the first domestic appliance may include data related to a fault of one or more components used in the first domestic appliance. For example, the fault code data for the first domestic appliance may include sensor data from a sensor onboard of the first domestic appliance.

In some embodiments, the fault code data for the first domestic appliance is obtained, at the remote server, from a first user account associated with the first domestic appliance. As used herein a domestic appliance may be “associated with” a user account in that a user is logged into the user account on a user device (e.g., a smartphone, smartwatch, tablet, or the like) and the user device may have been commissioned to the user account (e.g., verified or authorized to access the user account) in the cloud or other remote computing system or device. In this regard, in such embodiments, the fault code data is transmitted by a user account commissioned on a user device and received at the remote server.

In some other embodiments, the fault code data is obtained directly from the first domestic appliance. For instance, the first domestic appliance may be in operative communication with the remote server. A controller of the first domestic appliance may include a network interface such that the first domestic appliance may communicate over one or more networks with the remote server. The controller of the first domestic appliance may transmit the fault code data to the remote server when fault codes are detected at the first domestic appliance. For example, when a temperature reading, current reading, voltage reading, or other aggregate data received from one or more sensors of the first domestic appliance is determined to be outside of a predetermined fault threshold (e.g., a threshold that corresponds to a fault code), the controller of the first domestic appliance may transmit the fault code data to the remote server when fault codes are detected at the first domestic appliance.

In addition, the method 500 may include obtaining a geographic location of the first domestic appliance upon obtaining fault code data for the first domestic appliance. The geographic location of the first domestic appliance may correspond to the physical location or address of the first domestic appliance. In some embodiments, the geographic location for the first domestic appliance is obtained via a first user device associated with the first domestic appliance. That is, when or upon the first user device becoming connected with a local network (such as a household network that the first domestic appliance may be in operative communication with), the first user device obtains geo-location data (e.g., data indicative of a geographic location of the first user device). In some embodiments, the geo-location data may be obtain via Global Navigation Satellite System coordinates of the first user device. For instance, upon the user device making a connection to the network, a location module (e.g., a module operable to obtain the geo-location data of the first user device, such as a Global Positioning System [GPS] that is operable to receive location and position information from a plurality of GPS satellites, postal address information, cellular-network location, latitude-longitude coordinate, or the like) can be instructed by a controller of the first user device to obtain geo-location data of the first user device. Notably, the obtained data indicative of the geographic location of the first user device is indicative of the geographic location of the first domestic appliance.

In additional or alternative embodiments, the geographic location of the first domestic appliance may be obtained directly via the first domestic appliance. For example, the first domestic appliance may include a location module (e.g., a GPS module, a latitude-longitude module, or the like) that is operable to receive location or position information of the first domestic appliance. In such instances, upon installation or commissioning of the first domestic appliance, the location module may receive geo-location data (e.g., data indicative of the geographic location) of the first domestic appliance.

The method 500 may also include requesting technician service in response to or upon obtaining the fault code data or obtaining the geographic location of the first domestic appliance. For instance, a technician request may be transmitted, for instance, from the remote server to a technician account (e.g., of a technician that may be servicing the geographic location of the first domestic appliance. Upon requesting technician service, the first user account may transmit information indicative of a date and time of the technician service.

At 520, the method 500 may include performing, at the remote server, a servicing analysis, for instance, to identify one or more target user accounts. As used herein “target user accounts” may correspond to user accounts that are associated with target domestic appliances (e.g., domestic appliances that have previously experienced faults similar to the faults experienced by the first domestic appliance). In this regard, the servicing analysis may be based on the fault code data for the first domestic appliance (e.g., obtained at 510). The one or more target user accounts each may be associated with a discrete geographic location. For instance, each of the one or more target user accounts may be associated with a target domestic appliance having a geographic location that is separate and distinct from the geographic location of the first domestic appliance. For example, each of the one or more target user accounts may be associated with a target domestic appliance in a household, dwelling, or building that is separate and distinct from the household, dwelling, or building that houses the first domestic appliance.

The geographic location of each target user account of the one or more target user accounts may be within a predetermined area surrounding the geographic location of the first domestic appliance. For example, each target user account may be associated with a target domestic appliance that is within a predetermined distance to the first domestic appliance. In some embodiments, the predetermined area surrounding the geographic location of the first domestic appliance may correspond to a servicing area of a technician. In other words, the predetermined area surrounding the geographic location of the first domestic appliance may correspond to a geographical area that a technician may travel to, for instance, for the servicing of a domestic appliance. For example, the predetermined area may correspond to one hundred or less miles surrounding the geographic location of the first domestic appliance, such as fifty or less miles surrounding the geographic location of the first domestic appliance, or such as ten or less miles surrounding the geographic location of the first domestic appliance.

As should be appreciated, the predetermined area may be measured in any suitable manner. For example, the predetermined area may correspond to the travel distance (e.g., as measured by the distance covered on a road) a technician may have to travel from the geographic location of the first domestic appliance. As another example, the predetermined area may correspond to a square or circular mile area surrounding the geographic location of the first domestic appliance.

In some embodiments, performing the servicing analysis to identify one or more target user accounts includes searching a master register. The master register may include or may be configured as a database or data set that is stored within a memory of the remote server. In particular, searching the master register may include processing target user account queries to identify one or more target user accounts from a set of prospective user accounts. For instance, the set of prospective user accounts may include user accounts that are associated with domestic appliances within the predetermined area surrounding the geographic location of the first domestic appliance. In this regard, processing target user account queries may include searching, via one or more processing device of the remote server, geographic location data (e.g., addresses or locations) of the prospective user accounts to determine if they are within the predetermined area surrounding the geographic location of the first domestic appliance.

In addition, the master register may include historic fault code data that has been previously transmitted from the prospective domestic appliances. For instance, a prospective domestic appliance or a prospective user account associated with the prospective domestic appliance may have previously transmitted fault code data to the remote server. This fault code data may have been stored within the master register. At 520, performing the servicing analysis may include searching, via the one or more processing device of the remote server, the master register for historic fault code data that may correspond to the fault code data for the first domestic appliance (e.g., obtained at 510). For instance, prior to or during the method 500, the prospective domestic appliances may experience faults that result in fault code data being transmitted to the remote server. In this regard, the method 500, at 520, may include searching the master register for one or more user accounts from the prospective user accounts that have previously transmitted fault code data that corresponds to the fault code data for the first domestic appliance.

At 530, the method 500 may include implementing a responsive action upon identifying the one or more target user accounts. Implementing the responsive action upon identifying the one or more of target user accounts may include transmitting, from the remote server to the one or more target user accounts, service notifications. For instance, a message may be transmitted from the remote server to the user devices associated with the one or more target user accounts (e.g., identified at 520). The service notifications may include a technician service recommendation prompt based on an appliance type of the first domestic appliance (e.g., a style or configuration of the domestic appliance) or the fault code data of the first domestic appliance. For example, the technician service recommendation prompt may include messages related to an expected date or time that technician servicing may be available. For instance, the technician service recommendation prompt may include an expected date or time that is close to (e.g., the same day as or within a predetermined amount of time to) the data and time indicated by the first user account. As another example, the technician service recommendation prompt may include messages related to providing additional user information regarding the target domestic appliance. For instance, the technician service recommendation prompt may include messages requesting pictures of the target domestic appliance, information relating to the historic fault code data, or the like. As yet another example, the technician service recommendation prompt may include messages confirming the scheduling of the technician service.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of identifying a set of target user accounts, the method comprising:
obtaining, from a first user account at a remote server, fault code data for a first domestic appliance, the first user account being associated with the first domestic appliance;
performing, at the remote server, a servicing analysis to identify one or more target user accounts, the servicing analysis being based on the fault code data for the first domestic appliance; and
implementing a responsive action upon identifying the one or more target user accounts.

2. The method of claim 1, further comprising:
obtaining a geographic location of the first domestic appliance upon obtaining fault code data for the domestic appliance.

3. The method of claim 2, wherein obtaining a geographic location of the first domestic appliance comprises,
obtaining, from a first user device associated with the first user account, geo-location data of the first user device, wherein the obtained geo-location data of the first user device is indicative of the geographic location of the first appliance.

4. The method of claim 2, wherein the one or more target user accounts each are associated with a discrete geographic location, and wherein the geographic location of each target user account of the one or more target user accounts is within a predetermined area surrounding the geographic location of the first domestic appliance.

5. The method of claim 1, wherein the fault code data for the first domestic appliance comprises data related to a fault of one or more components used in the first domestic appliance.

6. The method of claim 1, wherein the fault code data for the first domestic appliance comprises sensor data from a sensor onboard of the first domestic appliance.

7. The method of claim 1, wherein performing, at the remote server, the servicing analysis to identify one or more target user accounts based on the fault code data for the first domestic appliance comprises
searching a master register stored within a memory of the remote server for one or more user accounts from a set of prospective user accounts that have previously transmitted fault code data that corresponds to the fault code data for the first domestic appliance, and
identifying the one or more target user accounts based on the search of the master register.

8. The method of claim 1, wherein implementing the responsive action upon identifying the set of target user accounts comprises
transmitting, from the remote server to the one or more target user accounts, service notifications.

9. The method of claim 8, wherein the service notifications comprise a technician service recommendation prompt.

10. The method of claim 9, wherein the technician service recommendation prompt is based on an appliance type of the first domestic appliance or the fault code data of the first domestic appliance.

11. The method of claim 1, wherein each target user account of the one or more target user accounts is associated with a target domestic appliance.

12. A system, comprising:
a first user account associated with a first domestic appliance in a first household;
a set of prospective user accounts, each prospective user account of the set of prospective user accounts associated with a discrete domestic appliance in a discrete household;
a remote server communicatively coupled with the first household and each prospective household of the set of prospective households, the remote server being operable for:
obtaining, from a first user account, fault code data for a first domestic appliance, the first user account being associated with the first domestic appliance;
performing a servicing analysis to identify one or more target user accounts from the set of prospective user accounts, servicing analysis being based on the fault code data for the first domestic appliance; and
implementing a responsive action upon identifying the one or more target user accounts.

13. The system of claim 12, wherein the remote server is further operable for:
obtaining a geographic location of the first domestic appliance upon obtaining fault code data for the domestic appliance,
wherein obtaining a geographic location of the first domestic appliance comprises obtaining, from a first user device associated with the first user account, geo-location data of the first user device, and
wherein the obtained geo-location data of the first user device is indicative of the geographic location of the first domestic appliance.

14. The system of claim 13, wherein the one or more target user accounts each are associated with a discrete geographic location, and wherein the geographic location of each target user account of the one or more target user accounts is within a predetermined area surrounding the geographic location of the first domestic appliance.

15. The system of claim 12, wherein the fault code data for the first domestic appliance comprises data related to a fault of one or more components used in the first domestic appliance.

16. The system of claim 12, wherein the fault code data for the first domestic appliance comprises sensor data from a sensor onboard of the first domestic appliance.

17. The system of claim 12, wherein performing the servicing analysis to identify one or more target user accounts based on the fault code data for the first domestic appliance comprises
searching a master register stored within a memory of the remote server for one or more user accounts from a set of prospective user accounts that have previously transmitted fault code data that corresponds to the fault code data for the first domestic appliance, and
identifying the one or more target user accounts based on the search of the master register.

18. The system of claim 12, wherein implementing the responsive action upon identifying the set of target user accounts comprises
transmitting service notifications to the one or more target user accounts.

19. The system of claim 18, wherein the service notifications comprise a technician service recommendation prompt.

20. The system of claim 19, wherein the technician service recommendation prompt is based on an appliance type of the first domestic appliance or the fault code data of the first domestic appliance.
